(19) United States
(12) Patent Application Publication
(10) Pub. No.: US 2026/0334385 A1
(43) Pub. Date: Oct. 29, 2026

(54) AGRICULTURAL WORK SYSTEM

(71) Applicant: Kubota Corporation, Osaka (JP)

(72) Inventors: Edwardo Arata YAMAMOTO MURAKAMI, Sakai-shi (JP); Ryutaro NAKANISHI, Sakai-shi (JP); Satoshi TANAKA, Sakai-shi (JP); Hiroki NISHIKORI, Sakai-shi (JP)

(21) Appl. No.: 19/711,489

(22) Filed: Jun. 17, 2026

Related U.S. Application Data
(63) Continuation of application No. PCT/JP2024/038682, filed on Oct. 30, 2024.

(30) Foreign Application Priority Data
Dec. 27, 2023 (JP) 2023-220750

(51) Int. Cl. A01G 13/21; A01B 51/02; H02S 20/30

(52) U.S. Cl. CPC A01G 13/21; A01B 51/023; H02S 20/30

(57) ABSTRACT

An agricultural work system includes a solar power generation mechanism including a solar power generation panel above a field, a rail between the solar power generation panel and the ground, an agricultural work device, and a movement mechanism to move the agricultural work device along the rail.

### CROSS REFERENCE TO RELATED APPLICATIONS

This application claims the benefit of priority to Japanese Patent Application No. 2023-220750 filed on Dec. 27, 2023 and is a Continuation Application of PCT Application No. PCT/JP2024/038682 filed on Oct. 30, 2024. The entire contents of each application are hereby incorporated herein by reference.

### BACKGROUND OF THE INVENTION

### 1. Field of the Invention

The present disclosure relates to agricultural work systems.

### 2. Description of the Related Art

Japanese Laid-Open Patent Publication No. 2014-236200 discloses a solar power generation facility including solar power generation panels and a support structure that supports the solar power generation panels above a field.

### SUMMARY OF THE INVENTION

An agricultural work system according to an example embodiment of the present disclosure includes a solar power generation mechanism including a solar power generation panel above a field, a rail between the solar power generation panel and ground, an agricultural work device, and a movement mechanism to move the agricultural work device along the rail.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a view illustrating an example of an overall configuration of an agricultural work system according to an example embodiment of the present invention.

FIG. 2 is a view illustrating a rail assembly.

FIG. 3 is a view illustrating a portion of a support structure including a work assembly, and a solar power generation mechanism.

FIG. 4 is a view illustrating another example of an end effector.

FIG. 5 is a view illustrating a movement mechanism.

FIG. 6 is a view for describing movement of a movement mechanism when the movement mechanism passes through a connecting portion between a first rail and a second rail.

FIG. 7 is a block diagram illustrating an example of functional configurations of a controller and a work assembly.

FIG. 8 is a functional block diagram illustrating an example of quality control processing performed by the controller.

### DETAILED DESCRIPTION OF THE EXAMPLE EMBODIMENTS

The solar power generation facility can perform solar power generation while performing agriculture, and can effectively use the field.

On the other hand, further improvement in efficiency is also desired in management work and agricultural work in the field. Among them, the present inventor has discovered a new measure capable of improving the efficiency of management work and agricultural work of the field while effectively utilizing the field by installing solar power generation panels.

According to example embodiments of the present disclosure, it is possible to improve efficiency of management work of a field and agricultural work.

First, contents of the example embodiments will be listed and described.
(1) An agricultural work system according to an example embodiment of the present disclosure includes a solar power generation mechanism including a solar power generation panel above a field, a rail between the solar power generation panel and ground, an agricultural work device, and a movement mechanism to move the agricultural work device along the rail.

According to the above configuration, it is possible to easily install the agricultural work device capable of moving across the entire field by providing the rail on the support structure supporting the solar power generation mechanism or using the support structure supporting the solar power generation mechanism as the rail.

As a result, it is possible to improve efficiency of management work of the field and agricultural work.
(2) In the agricultural work system of (1), the agricultural work device may include an arm including an upper end fixed to the movement mechanism, and an end effector detachably provided at a lower end of the arm.

In this case, a plurality of end effectors configured to perform different types of work can be used while replacing the end effectors, and the agricultural work device can be caused to perform a plurality of types of work.
(3) In the agricultural work system of (2), the solar power generation mechanism may further include an adjustment mechanism to adjust a solar radiation amount of the field.

In this case, the solar radiation amount of the field can be adjusted.
(4) In the agricultural work system of (3), the adjustment mechanism may include an elevation angle variable mechanism to support the solar power generation panel such that an elevation angle of the solar power generation panel is changeable.

In this case, by changing the elevation angle of the solar power generation panel, the wind volume of the field can be adjusted in addition to the solar radiation amount of the field.
(5) In a case where the agricultural work system of (4) further includes an environment detector to detect an environment of the field, the elevation angle variable mechanism may be configured or programmed to control the elevation angle based on the environment of the field.

In this case, according to the environment of the field, the elevation angle of the solar power generation panel can be controlled such that the solar radiation amount and the wind volume are appropriate for the crops in the field.
(6) Further, in a case where the agricultural work system of (4) described above further includes a state detector to detect a state of a crop in the field, the elevation angle variable mechanism may be configured or programmed to control the elevation angle based on the state of the crop.

In this case, it is possible to control the elevation angle of the solar power generation panel such that the solar radiation amount and the wind volume are appropriate for the crops in the field.
(7) In the agricultural work system of (4), in a case where the end effector includes a state detector to detect a state of a crop in the field, it is preferable that the elevation angle variable mechanism is configured to adjust the elevation angle based on a state of the crop.

Also in this case, it is possible to control the elevation angle of the solar power generation panel so that the solar radiation amount and the wind volume are appropriate for the crops in the field.
( 8) In the agricultural work system of (5), in a case where the arm includes a manipulator configured to change a position of the end effector within a predetermined range around the movement mechanism, it is preferable that the movement mechanism and the manipulator are configured to be operationally controllable based on an environment of the field.

In this case, the movement mechanism and the manipulator can perform a work operation according to the environment of the field.
(9) In the agricultural work system of (6), in a case where the arm includes a manipulator configured to change a position of the end effector within a predetermined range around the movement mechanism, it is preferable that the movement mechanism and the manipulator are configured or programmed to control operations based on a state of the crop.

In this case, the movement mechanism and the manipulator can perform a work operation according to the state of the crop.
(10) In addition, in a case where the agricultural work system of (2) further includes an environment detector to detect an environment of the field, it is preferable that the arm includes a manipulator configured to change a position of the end effector within a predetermined range around the movement mechanism, and the movement mechanism and the manipulator are configured to be operationally controllable based on an environment of the field.

In this case, the movement mechanism and the manipulator can perform a work operation according to the environment of the field.
(11) In a case where the agricultural work system of (2) further includes a state detector to detect a state of a crop in the field, it is preferable that the arm includes a manipulator configured to change a position of the end effector within a predetermined range around the movement mechanism, and the movement mechanism and the manipulator are configured to be operationally controllable based on a state of the crop.

In this case, the movement mechanism and the manipulator can perform a work operation according to the state of the crop.
(12) In the agricultural work system of (2), the work to be performed by the end effector may include any of harvesting a crop, pruning the crop, water spraying, fertilization of the crop, agrochemical spraying, detecting a state of the crop, imaging the crop, pest control, or charging of equipment in the field.

In this case, the agricultural work device can perform a plurality of types of agricultural work according to the end effector.
(13) In a case where the agricultural work system of (2) further includes another agricultural work device, and another movement mechanism to move the another agricultural work device along the rail, it is preferable that the another agricultural work device includes another end effector configured to perform an agricultural work different from the agricultural work to be performed by the end effector.

In this case, a plurality of agricultural work devices can cooperate to perform agricultural work.
(14) The agricultural work system according to any one of (1) to (13) may further include a power supply to supply power generated by the solar power generation panel to the agricultural work device or the movement mechanism.

In this case, the power from the solar power generation panel can be effectively used.
(15) It is preferable that the agricultural work system according to any one of (1) to (14) further includes a position detector to detect a position of the agricultural work device.
(16) In the agricultural work system according to any one of (6), (7), and (11), the state detector may include at least one of a sugar content sensor, an acidity sensor, or an imaging device.
(17) In the agricultural work system according to any one of (1) to (16), the rail may be included in a support structure that supports the solar power generation panel.

In this case, the movement mechanism and the agricultural work device can be installed without separately installing a dedicated rail other than the support structure.
(18) The agricultural work system according to any one of (1) to (16) may further include a support structure to support the solar power generation panel, in which the rail may be supported by the support structure.

In this case, the rail can be installed without separately providing a pillar for supporting the rail other than the support structure.

Hereinafter, example embodiments will be described with reference to the drawings.

Note that at least some of the example embodiments described below may be arbitrarily combined.

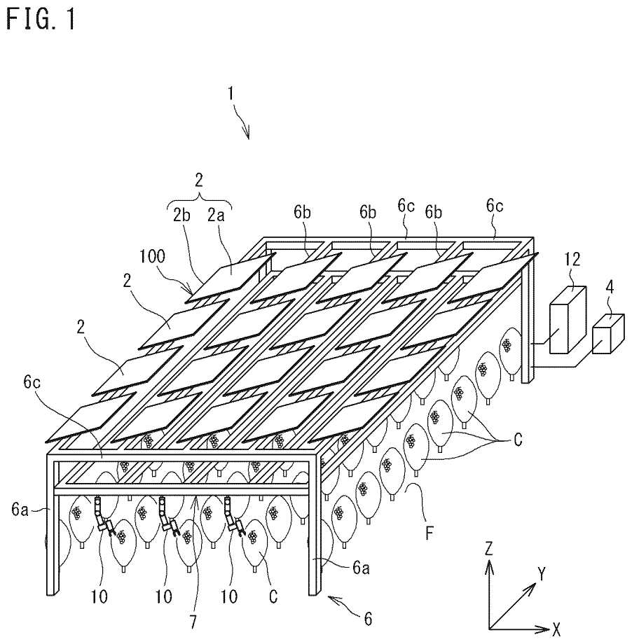

FIG. 1 is a diagram illustrating an example of an overall configuration of an agricultural work system according to an example embodiment.

In FIG. 1, an agricultural work system 1 includes a solar power generation mechanism 100 installed above a field F. The agricultural work system 1 can perform solar power generation while cultivating a crop in the field F by the solar power generation mechanism 100.

The crop C cultivated in the field F is, for example, grapes.

Further, the agricultural work system 1 is configured or programmed to control (manage) the state of the crop C in the field F and a function of supporting the farmwork in the field F.

Note that, in the following description, three directions orthogonal to each other in each drawing are an X direction, a Y direction, and a Z direction. The Z direction is a vertical direction.

The agricultural work system 1 includes a controller 4, a support structure 6, a rail assembly 7, and a plurality of work assemblies 10 in addition to the solar power generation mechanism 100.

The solar power generation mechanism 100 includes a plurality of solar power generation panels 2 and a plurality of elevation angle variable mechanisms. Each of the plurality of solar power generation panels 2 includes a plurality of cells 2a and a panel frame 2b. The plurality of cells 2a is arranged on the panel frame 2b. The panel frame 2b holds the plurality of cells 2a in a panel shape.

The voltage of the power output from the plurality of solar power generation panels 2 is adjusted via a DC/DC converter or the like and supplied to a power conditioner (PCS) 12. The PCS 12 converts the power from the plurality of solar power generation panels 2 into an alternating current, and supplies the power to a load connected to the PCS 12. In addition, the PCS 12 is connected to a commercial AC power supply system, and may supply power from the plurality of solar power generation panels 2 to the system.

Further, each element or functional portion of the present system 1 is connected to the PCS 12 as a load. Therefore, the power of the plurality of solar power generation panels 2 is supplied to each element or functional portion of the present system 1.

That is, the PCS 12 functions as a power supply device to supply the power generated by the solar power generation panels 2 to the work assemblies 10 (the agricultural work device or the movement mechanism).

In this case, the power from the solar power generation panel 2 can be effectively used.

Note that the agricultural work system 1 may include a storage battery to store the output of the DC/DC converter. The DC power stored in the storage battery is used as power output at a charging station to be described later or DC power required in the present system 1.

The support structure 6 supports the plurality of solar power generation panels 2. The support structure 6 includes a plurality of pillars 6a, a plurality of beam frames 6b, and a plurality of support frames 6c. The plurality of pillars 6a, the plurality of beam frames 6b, and the plurality of support frames 6c are rod-shaped structures made of a steel material, an aluminum alloy material, or the like.

The plurality of (for example, four in the illustrated example) pillars 6a is erected in the Z direction at the edge of the field F. Note that, in FIG. 1, the pillars 6a are provided at four corners of the field F.

The plurality of (for example, five in the illustrated example) beam frames 6b is provided above the field F. The plurality of beam frames 6b extends in the Y direction. The plurality of beam frames 6b is arranged side by side in the X direction at regular intervals.

The plurality of elevation angle variable mechanisms described above is provided above the plurality of beam frames 6b, respectively. The plurality of elevation angle variable mechanisms support the solar power generation panels 2 on the beam frames 6b such that the elevation angles of the solar power generation panels 2 are changeable.

The plurality of (for example, two in the illustrated example) support frames 6c extends in the X direction. The plurality of support frames 6c connects the distal ends of the plurality of beam frames 6b and the distal ends of the pillars 6a. Thereby, the plurality of beam frames 6b and the plurality of solar power generation panels 2 are supported above the field F.

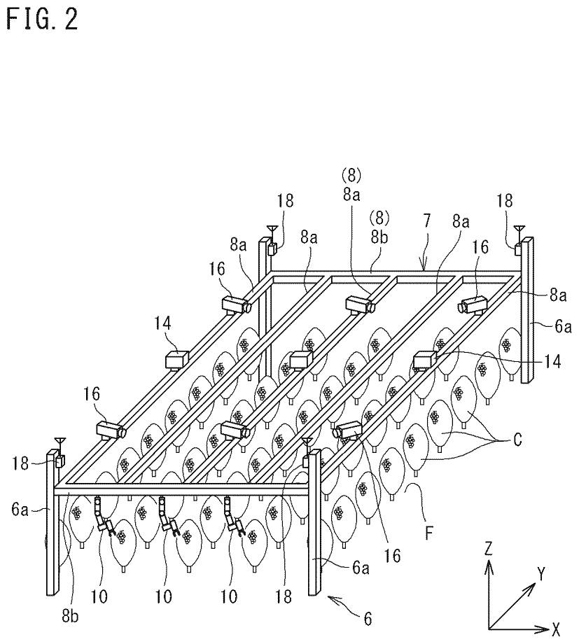

FIG. 2 is a diagram illustrating the rail assembly 7. FIG. 2 illustrates the support structure 6 in a state in which the solar power generation mechanism 100, the beam frames 6b of the support structure 6, and the support frame 6c are removed.

The rail assembly 7 constitutes a track on which the plurality of work assemblies 10 travels. The rail assembly 7 is provided between the plurality of solar power generation panels 2 and the ground of the field F.

The rail assembly 7 includes a plurality of rails 8. The plurality of rails 8 is, for example, rod-shaped structures made of C-shaped steel. The plurality of rails 8 includes a plurality of first rails 8a and a plurality of second rails 8b.

The plurality of (for example, five in the illustrated example) first rails 8a extends in the Y direction. The plurality of first rails 8a is arranged side by side in the X direction at regular intervals.

The plurality of (for example, two in the illustrated example) second rails 8b extends in the X direction. The plurality of second rails 8b connects the distal ends of the plurality of first rails 8a to each other. Thus, the rail assembly 7 is configured in a lattice shape. In other words, the rail assembly 7 is a rail network in which the rails 8 are combined.

The rail assembly 7 is provided with a plurality of environment detectors 14. The plurality of environment detectors 14 is provided at predetermined intervals over the entire field F. The plurality of environment detectors 14 includes, for example, a temperature and humidity sensor and a wind volume sensor. The environment detector 14 detects temperature, humidity, and wind volume as the environment of the field F. The environment detector 14 is communicably connected to the controller 4. The output of the environment detector 14 is supplied to the controller 4.

Further, the rail assembly 7 is provided with a plurality of cameras 16. The plurality of cameras 16 is provided at predetermined intervals over the entire field F. The plurality of cameras 16 images the crop C in the field F. The plurality of cameras 16 is communicably connected to the controller 4. The image data output from the plurality of cameras 16 is provided to the controller 4.

Further, the support structure 6 is provided with a plurality of wireless communication devices 18. The plurality of wireless communication devices 18 is provided at predetermined intervals over the entire field F. The plurality of wireless communication devices 18 is configured or programmed to perform wireless communication with the work assemblies 10. The plurality of wireless communication devices 18 is connected to the controller 4. The controller 4 can communicate with the work assemblies 10 via a plurality of wireless communication devices 18.

The plurality of wireless communication devices 18 and the work assemblies 10 communicate with each other by, for example, a wireless LAN. That is, the plurality of wireless communication devices 18 serves as access points. In the following description, the plurality of wireless communication devices 18 may be referred to as access points 18.

Note that FIG. 2 illustrates a case where the access points 18 are provided on the four pillars 6a, respectively. The access points 18 may be provided on the support structure 6 or may be provided on the rail assembly 7.

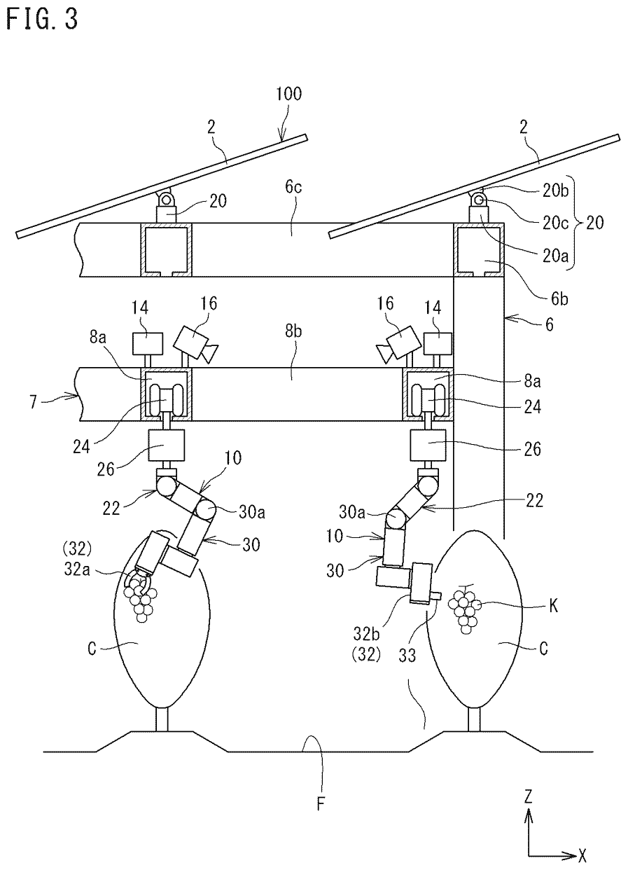

FIG. 3 is a view illustrating a portion of a support structure 6 including the work assemblies 10, and a solar power generation mechanism 100.

As described above, the solar power generation panels 2 and elevation angle variable mechanisms 20 are provided on the beam frames 6b of the support structure 6. Each elevation angle variable mechanism 20 includes a base 20a, a support portion 20b, and an actuator 20c. The base 20a is provided on the upper surface of the beam frame 6b. The support portion 20b is pivotally provided on the base 20a. The support portion 20b rotates about an axis in the Y direction. The support portion 20b is fixed to the lower surface of the solar power generation panel 2. Thus, the solar power generation panel 2 is rotatable with respect to the base 20a together with the support portion 20b. As a result, the elevation angle variable mechanism 20 supports the solar power generation panel 2 such that the elevation angle of the solar power generation panel 2 is changeable. The actuator 20c drives the rotation of the support portion 20b. That is, the elevation angle of the solar power generation panel 2 can be changed by controlling the actuator 20c.

The actuator 20c is controlled by the controller 4.

In the present example embodiment, the solar radiation amount of the field F and the wind volume of the field F can be adjusted by changing the elevation angle of the solar power generation panel 2 by the elevation angle variable mechanism 20.

That is, the elevation angle variable mechanism 20 constitutes an adjustment mechanism that adjusts the solar radiation amount of the field F.

The plurality of work assemblies 10 is suspended from the rail assembly 7. The plurality of work assemblies 10 moves along the rails 8 of the rail assembly 7, and has a function of performing farmwork on the crops C of the field F and a function of detecting the state of the crops C.

In FIG. 3, each of the plurality of work assemblies 10 includes an agricultural work device 22, a movement mechanism 24, and a control box 26.

The agricultural work device 22 is configured to perform agricultural work performed on the crop C and function as a sensor to detect a state of the crop C.

The movement mechanism 24 is configured to move the agricultural work device 22 along the rails 8a and 8b.

The agricultural work device 22 includes an arm 30 and an end effector 32.

An upper end of the arm 30 is fixed to the movement mechanism 24. The arm 30 extends downward from the movement mechanism 24. The end effector 32 is provided at the lower end of the arm 30.

The arm 30 is a manipulator configured to change the position of the end effector 32 within a predetermined range around the movement mechanism 24. The arm 30 is an articulated manipulator including a plurality of joints 30a.

The end effector 32 is configured to perform a work operation such as farmwork on the crop C. The end effector 32 is disposed at the work position by the arm 30. The end effector 32 performs a work operation at the work position.

The end effector 32 is detachably attached to the arm 30.

In the present example embodiment, a plurality of types of the end effector 32 is prepared for each work operation. Therefore, the agricultural work device 22 can perform a plurality of types of work operations by replacing the end effector 32.

The work to be performed by the end effector 32 includes harvesting the crop C, pruning the crop C, water spraying, fertilization of the crop C, agrochemical spraying, detecting a state of the crop C, imaging the crop C, pest control, and charging of equipment in the field F.

Thus, the end effector 32 includes the end effector 32 for harvesting work, the end effector 32 for pruning, the end effector 32 for water spraying, the end effector 32 for fertilization, the end effector 32 for agrochemical spraying, the end effector 32 for detecting the state of the crop C, the end effector 32 for imaging, the end effector 32 for pest control, and the end effector 32 for charging of equipment in the field F.

Note that the equipment in the field F targeted by the end effector 32 to charge include agricultural work vehicles such as an electric tractor and an electric rover in addition to the other work assemblies 10.

In FIG. 3, the end effector 32a is for harvesting. The end effector 32a for harvesting can grip the fruit K of the crop C and perform harvesting work of the fruit K.

In FIG. 3, the end effector 32b is configured to detect the state of the crop C. The end effector 32b for state detection has a sensor 33 at the distal end. The sensor 33 includes a sensor that detects the sugar content and acidity of the crop C (fruit K) and a sensor that detects the moisture content of the crop C. That is, the state of the crop C includes sugar content, acidity, and moisture content. The arm 30 brings the sensor 33 of the end effector 32b for state detection close to the crop C. The sensor 33 can detect the state of the crop C at a position close to the detection target.

Further, the sensor 33 also includes a camera that images the crop C (fruit K).

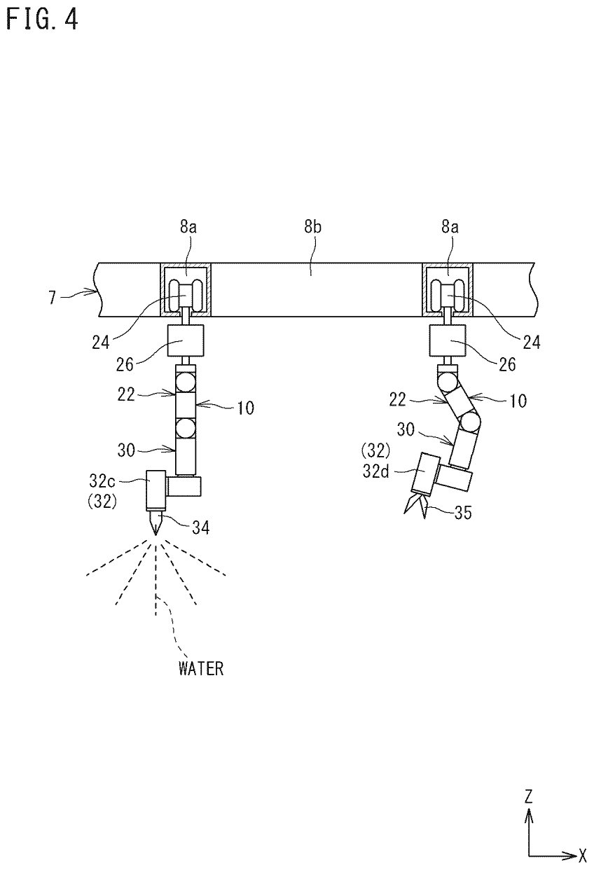

FIG. 4 is a view illustrating another example of the end effector 32.

In FIG. 4, the end effector 32c is for water spraying. The end effector 32c for water spraying includes a water spray nozzle 34. The end effector 32c for water spraying supplies water to the crops C by spraying water from the water spray nozzle 34. Thus, irrigation for the crop C is performed.

In addition, the end effector 32c for water spraying is used as the end effector 32 for fertilization if it is used for supplying fertilizer. In addition, the end effector 32c for water spraying is used as the end effector 32 for agrochemical spraying if it is used for supplying agrochemicals.

In FIG. 4, the end effector 32d is for pruning. The end effector 32d for pruning includes pruning scissors 35. The end effector 32d for pruning can perform pruning of the crop C by using the pruning scissors 35.

The plurality of types of end effectors 32 is stocked in, for example, a stocker (not illustrated). The stocker is installed at a position where the work assembly 10 can move. When replacing the end effector 32, the work assembly 10 moves to the position of the stocker. The agricultural work device 22 can replace the end effector 32 at the position of the stocker. The end effector 32 corresponding to the work to be performed is attached to the agricultural work device 22.

As described above, since the agricultural work device 22 of the present example embodiment includes the arm 30 fixed to the movement mechanism 24 and the end effector 32 detachably provided at the lower end of the arm 30, a plurality of end effectors 32 configured to perform different types of work can be used while replacing the end effectors, and the agricultural work device 22 can be caused to perform a plurality of types of work.

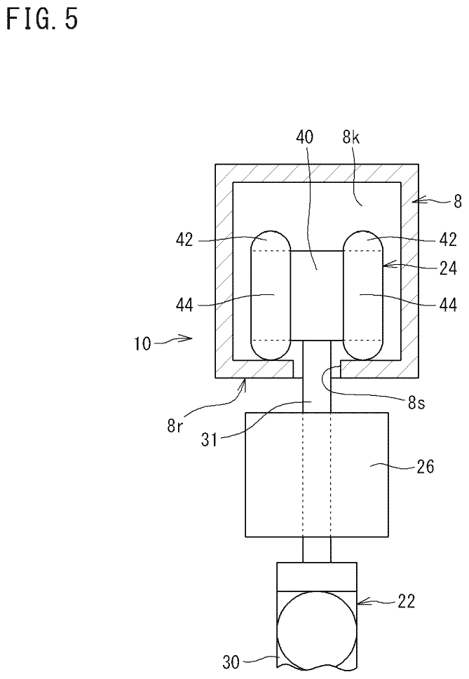

FIG. 5 is a diagram illustrating the movement mechanism 24. FIG. 5 illustrates the movement mechanism 24 when one of the rails 8 is viewed from the direction in a longitudinal direction. Thus, the rail 8 is illustrated in a cross-sectional view along a plane orthogonal to the longitudinal direction of the rail 8.

As described above, the rail 8 is C-shaped steel. Therefore, a bottom plate 8r of the rail 8 includes a slit 8s in the longitudinal direction. The bottom plate 8r of the rail 8 is included in the lower surface of the rail 8. The slit 8s communicates the inside and the outside of the rail 8. The slit 8s opens downward.

The movement mechanism 24 travels in an internal space 8k of the rail 8.

The movement mechanism 24 includes a main body 40, a pair of wheels 42, and a pair of motors 44.

The pair of motors 44 is provided at both ends of the main body 40. Rotating shafts of the pair of motors 44 are provided concentrically with each other. Each of the pair of motors 44 is a so-called in-wheel motor. Therefore, the pair of wheels 42 is integrally provided on the outer peripheral surfaces of rotors (not illustrated) of the pair of motors 44. The pair of motors 44 rotatably drives the pair of wheels 42 while constituting an axle of the pair of wheels 42.

The main body 40 is interposed between the pair of motors 44 and integrally connects the pair of motors 44. A coupling shaft 31 is fixed to the main body 40. The coupling shaft 31 is a member that couples the movement mechanism 24 and the arm 30. The coupling shaft 31 extends downward from the main body 40, passes through the slit 8s, and protrudes from the bottom plate 8r of the rail 8. The lower end of the coupling shaft 31 is connected to the arm 30. Thus, the coupling shaft 31 couples the movement mechanism 24 and the arm 30 (agricultural work device 22).

Note that the pair of motors 44 is controlled independently of each other. Therefore, the pair of motors 44 may rotate in the same direction or rotate in opposite directions.

Since the bottom plate 8r of the rail 8 includes the slit 8s, the coupling shaft 31 protrudes from the bottom plate 8r of the rail 8. Further, the pair of wheels 42 is in contact with the bottom plate 8r. Thus, the work assembly 10 is suspended on the rail 8. When the pair of wheels 42 are rotationally driven by the pair of motors 44, the work assembly 10 travels on the bottom plate 8r. Thus, the work assembly 10 can move along the rail 8 of the rail assembly 7.

The work assembly 10 can move along the first rail 8a and the second rail 8b included in the rail 8. Therefore, the work assembly 10 can move over the entire region of the rail assembly 7.

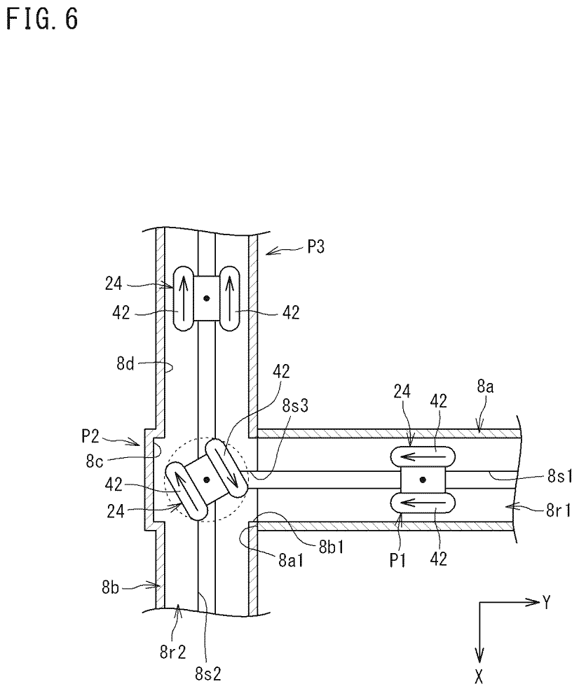

FIG. 6 is a diagram for describing the movement of the movement mechanism 24 when passing through the connecting portion between the first rail 8a and the second rail 8b. FIG. 6 illustrates the movement mechanism 24 when the rail 8 is viewed from above. Thus, the rail 8 is illustrated as a cross-sectional view along the X-Y plane.

FIG. 6 illustrates a state where the movement mechanism 4 moves from a position P1 to a position P3 via the position P2. The position P1 is a position on the first rail 8a. At the position P1, the movement mechanism 24 travels on the first rail 8a toward the second rail 8b. Therefore, at this time, the pair of motors 44 of the movement mechanism 24 rotate in the same direction.

An end 8a1 of the first rail 8a is connected to an opening 8b1 of the second rail 8b. The opening 8b1 is provided corresponding to the end 8a1. A bottom plate 8r1 of the first rail 8a and a bottom plate 8r2 of the second rail 8b are connected at the opening 8b1.

Therefore, the movement mechanism 24 traveling on the first rail 8a can enter the internal space of the second rail 8b through the opening 8b1.

The bottom plate 8r2 of the second rail 8b is provided with a connecting slit 8s3 in addition to a slit 8s2. The connecting slit 8s3 is connected to a slit 8a2 of the second rail 8b at a right angle. The connecting slit 8s3 connects the slit 8a2 of the second rail 8b and a slit 8s1 of the first rail 8a.

When entering the internal space of the second rail 8b through the opening 8b1, the movement mechanism 24 travels inside the second rail 8b along the connecting slit 8s3 and reaches a point where the slit 8s2 and the connecting slit 8s3 are connected.

The position P2 is a point where the slit 8s2 and the connecting slit 8s3 are connected.

When the movement mechanism 24 reaches the position P2, the pair of motors 44 is controlled to rotate in opposite directions. Thereby, the movement mechanism 24 rotates on the spot while being located at the position P2. That is, the movement mechanism 24 changes its direction while being located at the position P2. When the rotating shafts of the pair of motors 44 become substantially parallel to the Y direction, the movement mechanism 24 ends the direction change, starts traveling along the slit 8s2 of the second rail 8b, and proceeds to the position P3.

As described above, the movement mechanism 24 passes through the connecting portion between the first rail 8a and the second rail 8b.

As described above, the movement mechanism 24 (work assembly 10) can move between the first rail 8a and the second rail 8b, and can move over the entire region of the rail assembly 7.

Note that, in the second rail 8b, a relief portion 8c is provided in a portion facing the opening 8b1. The relief portion 8c is a portion recessed outward with respect to the inner surface 8d of the second rail 8b. The relief portion 8c is provided to prevent the movement mechanism 24 that changes its direction at the position P2 from coming into contact with the inner surface 8d of the second rail 8b.

As illustrated in FIG. 5, the control box 26 is fixed to the coupling shaft 31. The control box 26 accommodates a controller that controls each element or functional portion of the work assembly 10, a storage battery, a wireless communication device, and the like therein.

As described above, in the present example embodiment, since the rail assembly 7 is provided on the support structure 6 that supports the solar power generation panels 2, the agricultural work device 22 (work assembly 10) that can move over the entire field F can be easily installed.

As a result, it is possible to improve the efficiency of the management work and the agricultural work of the field F.

Further, in the present example embodiment, since the rail assembly 7 is supported by the support structure 6, the rail assembly 7 can be installed without providing pillars for supporting the rail assembly 7 separately other than the support structure 6.

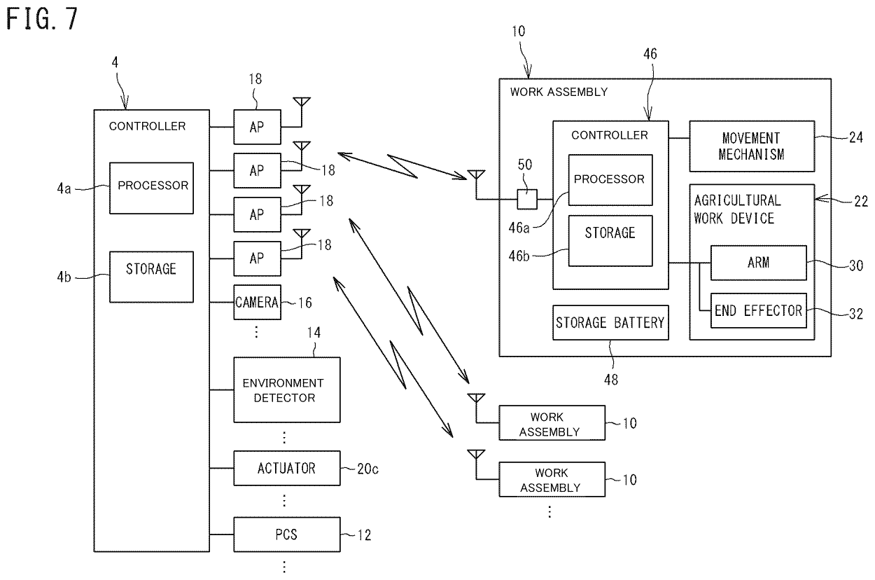

FIG. 7 is a block diagram illustrating an example of functional configurations of the controller 4 and the work assemblies 10.

The controller 4 may be a computer such as a personal computer or a server. The controller 4 may be a smartphone, a tablet, or the like, or may be a computer system on a cloud.

A plurality of access points 18, a plurality of environment detectors 14, a plurality of cameras 16, and a plurality of actuators 20c are connected to the controller 4.

The controller 4 and these devices are connected to communicate with each other in a wired or wireless manner. The controller 4 can be configured or programmed to control these devices by giving control commands. Further, the controller 4 can receive outputs given from these devices.

The controller 4 is communicably connected to various information servers via a network. The network may be a local network or a global network. Furthermore, the network may be configured by combining a local network and a global network.

The controller 4 includes a processor 4a and a storage 4b.

The processor 4a is, for example, one or more processors of various types adapted to control a computer, such as a central processing unit (CPU), a graphics processing unit (GPU), a digital signal processor (DSP), and a field-programmable gate array (FPGA).

The storage 4b is, for example, a flash memory, a hard disk, a read only memory (ROM), a random access memory (RAM), or the like.

The storage 4b stores a computer program to be performed by the processor 4a and necessary information. The processor 4a is configured or programmed to perform various processing functions of the processor 4a by executing a computer program stored in a computer-readable non-transitory recording medium such as the storage 4b.

The processor 4a is configured or programmed to control each element or functional portion of the agricultural work system 1 and performing processing of performing quality control of the crops C of the field F. The quality control processing will be described in detail later.

Further, the processor 4a is configured or programmed to perform processing of detecting the positions of the plurality of work assemblies 10. The processor 4a performs wireless LAN communication with the work assemblies 10 via the plurality of access points 18. The processor 4a acquires, from the plurality of access points 18, information regarding received signals when the signals from the work assemblies 10 are received. The processor 4a detects the positions of the work assemblies 10 based on the information regarding the received signals acquired from the plurality of access points 18. The information regarding the received signals includes a received signal strength indicator (RSSI) and channel state information (CSI).

The plurality of access points 18 is provided at predetermined intervals over the entire field F. That is, the positions of the plurality of access points 18 are known. Therefore, the positions of the work assemblies 10 as signal sources can be detected by analyzing the information regarding the received signals in the plurality of access points 18. The processor 4a detects the position of each of the plurality of work assemblies 10. The detected position of the work assembly 10 is used for quality control processing.

In the present example embodiment, since the solar power generation panels 2 are provided above the work assemblies 10, position detection using a GPS receiver may be difficult.

On the other hand, in the present example embodiment, since the position of the work assembly 10 is detected using the plurality of access points 18, the position of the work assembly 10 can be accurately detected even if the solar power generation panel 2 is provided above.

Note that the position of the work assembly 10 may be detected by distance measurement using a laser beam or by distance measurement using a stereo camera. In the position detection by the distance measurement, the position of the work assembly 10 is detected by measuring the distance between the work assembly 10 and the reference position.

The work assembly 10 includes a controller 46, a storage battery 48, and a wireless communication device 50 in addition to the agricultural work device 22 and the movement mechanism 24 described above.

The controller 46, the storage battery 48, and the wireless communication device 50 are accommodated in the control box 26. The controller 46 is configured or programmed to control the agricultural work device 22 and the movement mechanism 24.

The storage battery 48 supplies power to each element or each element or functional portion the work assembly 10.

The wireless communication device 50 is used for wireless communication with the controller 4. The wireless communication device 50 is configured or programmed to perform wireless LAN communication with a plurality of access points 18.

The controller 46 may be a computer. The agricultural work device 22, the movement mechanism 24, and the wireless communication device 50 are connected to the controller 46.

The controller 46 may be configured or programmed to control these devices by giving control commands. Further, the controller 46 can receive outputs given from these devices.

The controller 46 includes a processor 46a and a storage 46b.

The processor 46a is, for example, one or more processors of various types adapted to control a computer, such as a central processing unit (CPU), a graphics processing unit (GPU), a digital signal processor (DSP), and a field-programmable gate array (FPGA).

The storage 46b is, for example, a flash memory, a hard disk, a read only memory (ROM), a random access memory (RAM), or the like.

The storage 46b stores a computer program to be performed by the processor 46a and necessary information. The processor 46a is configured or programmed to perform various processing functions of the processor 46a by executing a computer program stored in a computer-readable non-transitory recording medium such as the storage 46b.

The processor 46a is configured or programmed to control the pair of motors 44 of the movement mechanism 24 to move the work assembly 10 to an arbitrary position in the rail assembly 7.

Further, the processor 46a is configured or programmed to control the arm 30 and the end effector 32 of the agricultural work device 22 to perform agricultural work.

The processor 46a moves the work assembly 10 to a predetermined position in the rail assembly 7 based on a command given from the controller 4, and controls the arm 30 and the end effector 32 to perform a predetermined operation.

Further, the processor 46a acquires the charge level of the storage battery 48, and moves the work assembly 10 to the charging station when the charge level becomes smaller than a predetermined charge level.

The charging station (not illustrated) is provided within a movement range of the work assembly 10. The work assembly 10 located in the charging station can receive a charge of the storage battery 48. As described above, the processor 46a can charge the storage battery 48 by moving the work assembly 10 to the charging station.

For example, the charging station is installed at the same position as the stocker. Therefore, the processor 46a moves the work assembly 10 to the charging station when determining that the storage battery 48 needs to be charged and when determining that the end effector 32 needs to be replaced.

Note that the plurality of work assemblies 10 may be equipped with the end effector 32 for performing the same type of work, or may be mounted with the end effector 32 for performing different types of work.

When the plurality of work assemblies 10 is equipped with the end effector 32 for performing different types of work, the plurality of work assemblies 10 can cooperate to perform agricultural work.

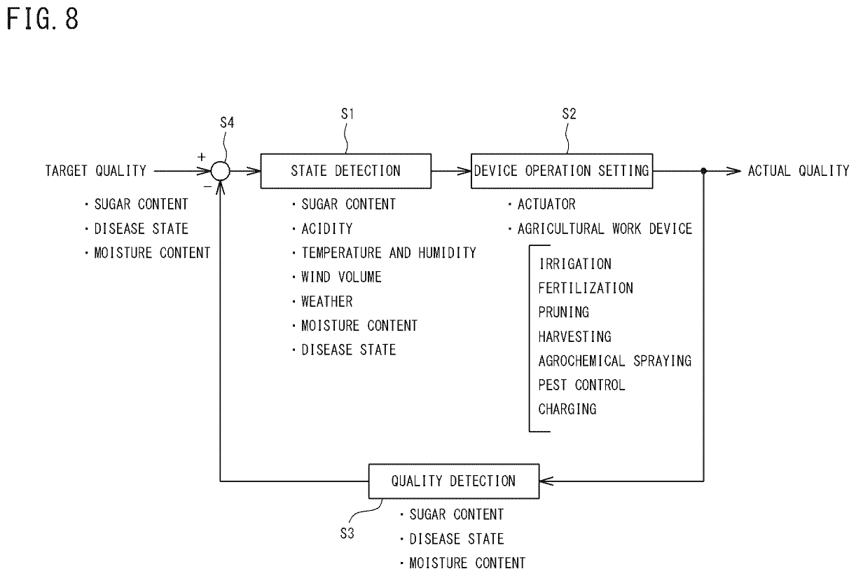

FIG. 8 is a functional block diagram illustrating an example of quality control processing performed by the controller 4.

The processor 4a of the controller 4 is configured or programmed to perform control to bring the quality of the crop C close to the target quality.

The quality to be controlled includes, for example, sugar content, disease state, and moisture content.

The target quality is given by an operator of the controller 4. The target quality includes a target value of each quality and a target state.

As illustrated in FIG. 8, when the target quality is given, the processor 4a first performs state detection (in FIG. 8, step S1). The state detection is processing of detecting the state of the crop C (fruit K) and the environment.

The state detected by the state detection is processing of detecting the sugar content and acidity of (the fruit K as) the crop C, the moisture content of the crop C, the disease state of the crop C, the temperature and humidity of the field F, the wind volume of the field F, and the weather of the field F.

The sugar content, acidity, and moisture content of the crop C are detected by the end effector 32b for state detection. Therefore, the processor 4a causes the arm 30 of the agricultural work device 22 to be equipped with the end effector 32b for state detection, and causes the agricultural work device 22 (work assembly 10) to perform state detection.

The temperature and humidity and the wind volume of the field F are detected by the environment detector 14.

The weather of the field F is acquired from the outside, for example, an information server connected via a network, input by an operator of the controller 4, or the like.

The disease state of the crop C is detected by the end effector 32b for state detection and the camera 16. Therefore, the processor 4a causes the arm 30 of the agricultural work device 22 to be equipped with the end effector 32b for state detection. The sensor 33 of the end effector 32b in this case includes an imaging camera. The processor 4a causes the agricultural work device 22 (work assembly 10) to image the crop C. The processor 4a determines whether or not the crop C is diseased based on the image data of the crop C captured by the sensor 33 or the camera 16. The processor 4a sets the determination result as the disease state of the crop C.

Further, the temperature and humidity of the field F and the wind volume of the field F included in the state of the field F are detected by the environment detector 14.

Next, the processor 4a performs device operation setting (in FIG. 8, step S2). The device operation setting is processing for causing each element or each element or functional portion the system 1 to perform agricultural work, environment setting, and the like based on each state obtained by state detection.

More specifically, the device operation setting includes setting of the actuator 20c, selection of the agricultural work to be performed by the agricultural work device 22, and performance of the selected agricultural work. The agricultural work to be selected includes irrigation, fertilization, pruning, harvesting, agrochemical spraying, pest control, and charging of equipment in the field F.

The processor 4a is configured or programmed to control the actuator 20c and the work assembly 10 (the agricultural work device 22 and the movement mechanism 24), and performs device operation setting.

In the device operation setting, the processor 4a determines a position to which the work assembly 10 is to be moved based on position information of the work assembly 10 (wireless communication device 50), and moves the work assembly 10 (movement mechanism 24). When the work assembly 10 reaches the position to be moved, the processor 4a controls the agricultural work device 22 and causes the agricultural work device 22 to perform work.

The processor 4a can adjust the elevation angle of the solar power generation panel 2 by setting and controlling the actuator 20c.

Further, the processor 4a selects agricultural work to be performed by the agricultural work device 22 from among irrigation, fertilization, pruning, harvesting, agrochemical spraying, pest control, and charging of equipment in the field F.

When the irrigation is selected, the processor 4a causes the arm 30 of the agricultural work device 22 to be equipped with the end effector 32c for water spraying, and causes the agricultural work device 22 (work assembly 10) to spray water. Accordingly, irrigation of the field F is performed.

When the fertilization is selected, the processor 4a causes the arm 30 of the agricultural work device 22 to be equipped with the end effector 32c for water spraying, and causes the agricultural work device 22 (work assembly 10) to spray liquid fertilizer. As a result, fertilization of the field F is performed.

When the pruning is selected, the processor 4a causes the arm 30 of the agricultural work device 22 to be equipped with the end effector 32d for pruning, and causes pruning of the crop C to be performed at a predetermined place of the field F.

When the harvesting is selected, the processor 4a causes the arm 30 of the agricultural work device 22 to be equipped with the end effector 32a for harvesting, and causes harvesting of the crop C (fruit K) to be performed at a predetermined place of the field F.

When the agrochemical spraying is selected, the processor 4a causes the arm 30 of the agricultural work device 22 to be equipped with the end effector 32c for water spraying, and causes the agricultural work device 22 (work assembly 10) to spray agrochemicals. As a result, agrochemical spraying of the field F is performed.

When the pest control is selected, the processor 4a causes the arm 30 of the agricultural work device 22 to be equipped with the end effector 32a for harvesting or the end effector 32d for pruning, and causes pruning of a portion where insect pests are present or direct removal of insect pests adhering to the crop.

In a case where the charging of equipment in the field F is selected, the processor 4a causes the arm 30 of the agricultural work device 22 to be equipped with the end effector 32 for charging. At this time, the processor 4a causes a storage battery, which stores electric power for charging, to be mounted on the work assembly 10. The work assembly 10 equipped with the end effector 32 for charging charges the power stored in the storage battery to the equipment in the field F including the other work assemblies 10.

In the device operation setting, the charging of the equipment in the field F may always be set. In this case, the work assembly 10 can receive charging from another work assembly 10 equipped with the end effector 32 for charging, in addition to the charging station.

After performing the device operation setting, the processor 4a performs quality detection (in FIG. 8, step S3). The quality detection is processing of detecting the quality to be controlled. Thus, quality detection includes detection of sugar content, detection of disease state, and detection of moisture content.

When the quality detection is completed, the processor 4a compares the target quality with the detected quality by the quality detection (in FIG. 8, step S4), and performs the state detection again based on the comparison result. That is, the processor 4a performs feedback control on the quality to be controlled. Thereafter, the processor 4a repeats these processes and performs control such that the actual quality approximates the target quality.

Note that the period from the device operation setting to the quality detection can be appropriately changed according to the quality to be controlled.

The processor 4a is configured or programmed to individually control the quality to be controlled.

First, control of sugar content will be described.

The processor 4a performs state detection when the target sugar content is given as the target quality. In the state detection, the processor 4a detects sugar content, acidity, temperature and humidity, wind volume, weather, and moisture content.

Next, the processor 4a performs device operation setting based on each state. In the device operation setting, the processor 4a sets and controls the actuator 20c to adjust the elevation angle of the solar power generation panel 2.

As a result, the processor 4a can adjust the solar radiation amount reaching the ground of the field F or adjust the wind volume of the field F based on the state of the field F.

Further, the processor 4a selects the agricultural work to be performed by the agricultural work device 22 and causes the agricultural work device 22 to perform the selected agricultural work based on each state. Here, the processor 4a selects irrigation.

That is, in the device operation setting in the control of the sugar content, the processor 4a performs quality control by combining the adjustment of the elevation angle of the solar power generation panel 2 and the irrigation.

For example, in the coloring period of the crop C (fruit K), when the sugar content is lower than the assumed sugar content (target sugar content), the processor 4a can increase the solar radiation amount by adjusting the elevation angle of the solar power generation panel 2 in order to accelerate the maturation of the fruit K.

Further, in a case where it is determined that there is water stress based on the moisture content, the processor 4a performs moisture adjustment by irrigation.

On the other hand, when the sugar content is higher than the assumed sugar content (target sugar content), the processor 4a can reduce the solar radiation amount by adjusting the elevation angle of the solar power generation panel 2, and can cause spraying of water so as to lower the temperature of the field F by irrigation.

Next, the control of the disease state will be described.

When a disease state is given as the target quality, the processor 4a performs state detection. In the state detection, the processor 4a detects a disease state. As described above, the processor 4a sets the determination result as to whether or not the crop C is diseased as a disease state.

Next, the processor 4a performs device operation setting based on the disease state. In the device operation setting, the processor 4a sets and controls the actuator 20c to adjust the elevation angle of the solar power generation panel 2.

Further, the processor 4a selects the agricultural work to be performed by the agricultural work device 22 and causes the agricultural work device 22 to perform the selected agricultural work based on each state. Here, the processor 4a selects irrigation, pruning, agrochemical spraying, and pest control.

That is, in the device operation setting in the control of the sugar content, the processor 4a performs quality control by combining adjustment of the elevation angle of the solar power generation panel 2, irrigation, pruning, agrochemical spraying, and pest control.

For example, the processor 4a can cause pruning of the portion determined to be in the disease state or spraying agrochemicals.

Further, regardless of the disease state, in the case of rainfall, the processor 4a causes the solar power generation panel 2 to be horizontal to function as an umbrella to reduce or prevent rain from hitting the crops C. This is because there is a possibility that the crop C is infected with a disease due to rain.

Further, in order to promote drying after rainfall, the elevation angle of the solar power generation panel 2 can be adjusted, or the crop C can be pinched by pruning, thereby enhancing ventilation or enhancing light exposure.

In addition to the control such as pruning, agrochemical spraying, and adjustment of the solar power generation panel 2, the processor 4a can also perform pest control by directly removing insect pests adhering to the crop C.

Next, the control of the moisture content will be described.

When the target moisture content is given as the target quality, the processor 4a performs state detection. In the state detection, the processor 4a detects temperature and humidity, wind volume, weather, and moisture content.

Next, the processor 4a performs device operation setting based on each state. In the device operation setting, the processor 4a sets and controls the actuator 20c to adjust the elevation angle of the solar power generation panel 2.

Further, the processor 4a selects the agricultural work to be performed by the agricultural work device 22 and causes the agricultural work device 22 to perform the selected agricultural work based on each state. Here, the processor 4a selects irrigation.

That is, in the device operation setting in the control of the moisture content, the processor 4a performs quality control by combining the adjustment of the elevation angle of the solar power generation panel 2 and the irrigation.

For example, in a case where the moisture content is larger than the assumed amount (target amount), the processor 4a can increase the solar radiation amount by adjusting the elevation angle of the solar power generation panel 2, and can increase the temperature of the field F to promote evaporation of moisture.

Conversely, in a case where the moisture content is smaller than the assumed amount (target amount), the processor 4a can reduce the solar radiation amount by adjusting the elevation angle of the solar power generation panel 2, increase the range of the shadow in the field F, and suppress the evaporation of the moisture. Furthermore, water can be supplied to the crop C through irrigation.

As described above, the agricultural work device 22 and the movement mechanism 24 of the present example embodiment are configured to be operable and controllable based on the environment of the field F.

Further, the agricultural work device 22 and the movement mechanism 24 of the present example embodiment are configured to be operable based on the state of the crop C.

It should be understood that the example embodiments disclosed herein are illustrative in all respects and are not restrictive.

For example, in the above example embodiments, the case where the rail assembly 7 is provided on the support structure 6 that supports the solar power generation panels 2 has been exemplified, but the beam frame 6b and the support frame 6c of the support structure 6, which are portions of the support structure 6, may have a function of a rail for the work assemblies 10.

In this case, the agricultural work device 22 (the work assemblies 10) can be installed without separately installing a dedicated rail other than the support structure 6.

In the above example embodiments, the case where the arm 30 of the agricultural work device 22 is an articulated manipulator has been exemplified. However, the arm 30 only needs to be capable of performing agricultural work, and may be an extendable shaft-shaped arm.

In addition, in the above example embodiments, the case where the crop C (fruit K) cultivated in the field F is grapes has been exemplified, but the present invention is not limited thereto, and other fruit trees, vegetables, and the like may be cultivated as the crop C.

Further, in the present example embodiments, the case where the elevation angle variable mechanism 20 is used as the adjustment mechanism to adjust the solar radiation amount of the field F has been exemplified. However, the adjustment mechanism only needs to be a mechanism configured to adjust the solar radiation amount of the field F. For example, the solar power generation panel 2 may be formed of a transparent panel, and a film having a light control function may be used as the adjustment mechanism. In this case, a light control film is used by being superimposed on the transparent solar power generation panel 2. Accordingly, the field F is irradiated with sunlight appropriately adjusted by passing through the solar power generation panel 2 and the light control film.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An agricultural work system comprising:
a solar power generation mechanism including a solar power generation panel above a field;
a rail between the solar power generation panel and ground;
an agricultural work device; and
a movement mechanism to move the agricultural work device along the rail.

2. The agricultural work system according to claim 1, wherein the agricultural work device includes:
an arm including an upper end fixed to the movement mechanism; and
an end effector detachably provided at a lower end of the arm.

3. The agricultural work system according to claim 2, wherein the solar power generation mechanism further includes an adjustment mechanism to adjust a solar radiation amount of the field.

4. The agricultural work system according to claim 3, wherein the adjustment mechanism includes an elevation angle variable mechanism to support the solar power generation panel such that an elevation angle of the solar power generation panel is changeable.

5. The agricultural work system according to claim 4, further comprising:
an environment detector to detect an environment of the field; wherein
the elevation angle variable mechanism is configured or programmed to control the elevation angle based on the environment of the field.

6. The agricultural work system according to claim 4, further comprising:
a state detector to detect a state of a crop in the field; wherein
the elevation angle variable mechanism is configured or programmed to control the elevation angle based on the state of the crop.

7. The agricultural work system according to claim 4, wherein
the end effector includes a state detector to detect a state of a crop in the field; and
the elevation angle variable mechanism is configured to adjust the elevation angle based on a state of the crop.

8. The agricultural work system according to claim 5, wherein
the arm includes a manipulator configured to change a position of the end effector within a predetermined range around the movement mechanism; and
the movement mechanism and the manipulator are configured to be operationally controllable based on an environment of the field.

9. The agricultural work system according to claim 6, wherein
the arm includes a manipulator configured to change a position of the end effector within a predetermined range around the movement mechanism; and
the movement mechanism and the manipulator are configured to be operationally controllable based on a state of the crop.

10. The agricultural work system according to claim 2, further comprising:
an environment detector to detect an environment of the field; wherein
the arm includes a manipulator configured to change a position of the end effector within a predetermined range around the movement mechanism; and
the movement mechanism and the manipulator are configured to be operationally controllable based on an environment of the field.

11. The agricultural work system according to claim 2, further comprising:
a state detector to detect a state of a crop in the field; wherein
the arm includes a manipulator configured to change a position of the end effector within a predetermined range around the movement mechanism; and
the movement mechanism and the manipulator are configured to be operationally controllable based on a state of the crop.

12. The agricultural work system according to claim 2, wherein the work to be performed by the end effector includes any of harvesting a crop in the field, pruning the crop, water spraying, fertilization of the crop, agrochemical spraying, detecting a state of the crop, imaging the crop, pest control, or charging of equipment in the field.

13. The agricultural work system according to claim 2, further comprising:
another agricultural work device; and
another movement mechanism to move the another agricultural work device along the rail; wherein
the another agricultural work device includes another end effector configured to perform an agricultural work different from the agricultural work to be performed by the end effector.

14. The agricultural work system according to claim 1, further comprising:
a power supply to supply power generated by the solar power generation panel to the agricultural work device or the movement mechanism.

15. The agricultural work system according to claim 1, further comprising:
a position detector to detect a position of the agricultural work device.

16. The agricultural work system according to claim 6, wherein the state detector includes at least one of a sugar content sensor, an acidity sensor, or an imaging device.

17. The agricultural work system according to claim 1, wherein the rail is included in a support structure that supports the solar power generation panel.

18. The agricultural work system according to claim 1, further comprising:
a support structure that supports the solar power generation panel; wherein
the rail is supported by the support structure.
